(19) United States
(12) Patent Application Publication
(10) Pub. No.: US 2018/0101833 A1
(43) Pub. Date: Apr. 12, 2018

(54) METHOD AND SYSTEM FOR ACCESS CONTROL VIA A PAYMENT NETWORK

(71) Applicant: MasterCard International Incorporated, Purchase, NY (US)

(72) Inventor: Pravin Parekh, Maharashtra (IN)

(21) Appl. No.: 15/692,411

(22) Filed: Aug. 31, 2017

(30) Foreign Application Priority Data
Oct. 10, 2016 (SG) 10201608474Q

(51) Int. Cl. G06Q 20/32; G06Q 10/02; G06Q 20/40; G06Q 10/10

(52) U.S. Cl. CPC G06Q 20/32; G06Q 10/10; G06Q 20/40; G06Q 10/025

(57) ABSTRACT

The present disclosure generally relates to a computerized method implemented, in part, on a host server for controlling access to a facility. The method comprises: receiving a data message comprising facility identification data provided by the facility and user account data provided by a mobile device of the user; generating a pseudo payment message comprising the user account data; communicating the pseudo payment message to a payment network for performing a pseudo payment process; and communicating an instruction message to the facility subsequent to completion of the pseudo payment process, wherein the facility is configured to change from the secured state to an unsecured state if the instruction message represents approval of the pseudo payment process, thereby providing, to the user, access to the facility.

### CROSS-REFERENCE TO RELATED APPLICATION

This application is a U.S. National Stage filing under 35 U.S.C. § 119, based on and claiming benefit of and priority to SG Patent Application No. 10201608474Q filed Oct. 10, 2016.

### TECHNICAL FIELD

The present disclosure generally relates to a method and system for access control via a payment network. More particularly, the present disclosure describes various embodiments of a method and system for controlling access to a facility associated with a user, e.g. facilities owned by or belonging to the user and/or facilities which the user is authorized or allowed to access, such that unauthorized users are prevented from gaining access to the facility.

### BACKGROUND

In the present disclosure, a facility may be defined as a place, amenity, or piece of equipment provided for a particular purpose. For example, a facility may be a private place/venue/location which a user is authorized to access, occupy, and use. Private places/venues/locations may include, but are not limited to, private residences, apartments, condominiums, commercial offices, and the like. A facility may be a hospitality facility/venue/location which a user has reserved or booked for his/her use. Hospitality facilities/venues/locations may include, but are not limited to, hotels/hotel rooms, accommodation/lodging rooms, and conference or meeting venues. A facility may also be an article or equipment which the user can access to use or operate. The equipment may include, but is not limited to, personal vehicles, mobility devices, rental vehicles, storage lockers, safe deposit boxes, and computer/electronic devices/machines. Notably, in some instances access is controlled by a physical lock, and in other instances access is controlled by a virtual lock (e.g. preventing access to a website or application on a computer).

In one example, facilities owned by or belonging to the user/owner may include his/her private apartment and personal car. The facilities are typically secured with a door and/or gate, and the door/gate has a physical lock to prevent unauthorized access. The physical lock may have a conventional pin tumbler lock as its internal mechanism and can be unlocked with a physical key. For example, unlocking with the key would cause a latch to be withdrawn from a strike plate, or a spindle to be released such that a knob or handle can be turned to withdraw the latch from the strike plate. Each physical lock is matched with a unique key. The user would need to hold multiple keys for different facilities, e.g. one house key for the private apartment and another car key for the personal car.

In more modern facilities, the facilities may be secured with electronic security devices, e.g. digital locks. The digital locks on the doors of the facilities may work together with the physical locks, such as by making use of the internal locking mechanism. Digital locks provide an electronic way of unlocking the doors to access the facilities, and can be unlocked with radio frequency identification (RFID) tags or keycards. Each digital lock has a unique radio frequency and is matched with a unique RFID tag. Like the physical locks, the user would need to hold multiple RFID tags for the different digital locks of different facilities.

One problem with holding multiple physical keys and/or RFID tags for accessing facilities of the user is that there is a risk of the user losing them, especially since these keys/tags are small items which can be misplaced quite often. Loss of a key/tag can cause the user to be locked out of a locked facility, and the user may need to requisite the services of a locksmith to break the lock in order for the user to access the facility. Further, the user would need to bear the cost of replacing the broken lock. There is also a risk of another person picking up the lost or misplaced key/tag. If the person has maligned intention and manages to find out the location of the user's facility, he/she would be able to unlock and access the facility. This may further result in theft of the user's valuables (if the facility is a private apartment) or even the loss of the facility itself (if the facility is a personal car).

Another problem is that if the user owns or holds many facilities, it may be cumbersome for the user to carry a large bunch of keys and tags whenever he/she is outside. With so many keys, the user may fumble through the bunch of keys and it becomes time-consuming for the user to find the correct key for any particular facility.

In another example, the facility may be a hotel room or rental vehicle. Conventionally, the user/customer/guest needs go to a reception area (e.g. hotel reception) to complete some formalities procedures in order to check-in and gain access to the facility. These procedures are typically required to verify the identity of the customer before access keys/cards are issued by the facility staff to the user.

One problem associated with this conventional way of checking in is that time may be wasted at the reception area while waiting for facility staff to complete the formalities procedures and issue the access keys/cards. During peak seasons, there may be large groups of tourists queuing for the reception area, adding to the time required before the user receives the access keys/cards. Another problem is that there is a risk of the user losing his/her access keys/cards. Loss of the access keys/cards causes the user to be locked out, particularly if the facility is a hotel room. The user may also have to undergo complex procedures in order to have a new access key/card re-issued by the hotel. There is also a risk of outsiders or impersonators with maligned intention unlocking and entering into the user's hotel room with the lost access key/card, which may further result in them stealing and absconding away with the user's valuables.

Therefore, in order to address or alleviate at least one of the aforementioned problems and/or disadvantages, there is a need to provide a method and system for controlling access to a facility, in which there is at least one improved feature over the aforementioned prior art.

### SUMMARY

According to a first aspect of the present disclosure, there is computerized method implemented on a host server for controlling access to a facility, a system implementing the method, and a non-transitory computer-readable medium storing computer-readable instructions that, when executed, cause a processor to perform steps of the method. The method comprises: receiving a data message comprising facility identification data provided by the facility and user account data provided by a mobile device of the user; generating a pseudo payment message comprising the user account data; communicating the pseudo payment message to a payment network for performing a pseudo payment process; and communicating an instruction message to the facility subsequent to completion of the pseudo payment process, wherein the facility is configured to change from the secured state to an unsecured state if the instruction message represents approval of the pseudo payment process, thereby providing, to the user, access to the facility.

According to a second aspect of the present disclosure, there is a computerized method implemented on a mobile device of a user for controlling access to a facility, a system implementing the method, and a non-transitory computer-readable medium storing computer-readable instructions that, when executed, cause a processor to perform steps of the method. The method comprises: communicating a request message from the mobile device to the facility for requesting identification data of the facility; receiving, by the mobile device, the facility identification data from the facility; generating, by the mobile device, a data message comprising the facility identification data and user account data; and communicating the data message from the mobile device to a host server for generating a pseudo payment message comprising the user account data, the pseudo payment message for subsequent communication from the host server to a payment network, wherein the facility is configured to change from the secured state to an unsecured state if the facility receives an instruction message representing approval of a pseudo payment process, thereby providing, to the user, access to the facility; and wherein the instruction message is communicated from the host server to the facility subsequent to completion of the pseudo payment process by the payment network based on the pseudo payment message.

An advantage of the above aspects of the present disclosure is that the user can directly gain access to the facility. The same mobile device can be used to gain access to multiple facilities associated with the user, thereby providing a single sign-on (SSO) form of access control. The pseudo payment process enables authentication of the user payment vehicle details, and consequently the user's identity, in the same manner as the user making a purchase. The user can thus rely on preexisting payment vehicle details (and preexisting reference authentication data if applicable for the payment vehicle) stored on the payment network. The same preexisting payment vehicle details (and preexisting reference authentication data if applicable) on the payment network can be extended for use with other or all facilities associated with the user, such that the user can use the mobile device as an SSO device and rely on the preexisting payment vehicle details to gain access to the facilities. Therefore, aspects of the present disclosure provide improved access control for the user to gain access to one or more facilities.

A method and system for controlling access to a facility according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a system for implementation of a method for controlling access to a facility, in accordance with an embodiment of the present disclosure.

FIG. 2 is a flowchart illustration of a method of FIG. 1 implemented on a host server for controlling access to a facility.

FIG. 3 is a flowchart illustration of the method of FIG. 1 implemented on a mobile device for controlling access to a facility.

FIG. 4A and FIG. 4B are illustrations of an accessing process in a method for controlling access to a facility, in accordance with an embodiment of the present disclosure.

FIG. 5A and FIG. 5B are illustrations of an accessing process in a method for controlling access to a facility, in accordance with another embodiment of the present disclosure.

FIG. 6A is a block diagram illustration of the technical architecture of a host server, in accordance with an embodiment of the present disclosure.

FIG. 6B is a block diagram illustration of the technical architecture of a mobile device, in accordance with an embodiment of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. As used herein, the term “set” corresponds to or is defined as a non-empty finite organization of elements that mathematically exhibits a cardinality of at least one (i.e., a set as defined herein can correspond to a unit, singlet, or single element set, or a multiple element set), in accordance with known mathematical definitions.

For purposes of brevity and clarity, descriptions of embodiments of the present disclosure are directed to a method and system for controlling access to a facility, in accordance with the drawings. As described above, a facility may be a private place/venue/location which a user can access, occupy, and use. Private places/venues/locations may include, but are not limited to, private residences, apartments, condominiums, commercial offices, and the like. A facility may be a hospitality facility/venue/location which a user has reserved or booked for his/her use. Hospitality facilities/venues/locations may include, but are not limited to, hotels/hotel rooms, accommodation/lodging rooms, conference/meeting venues, cinemas, theatres, and concert halls. A facility may also be an article or equipment which the user can access to use or operate. The equipment may include, but is not limited to, personal vehicles, mobility devices, rental vehicles, storage lockers, safe deposit boxes, and computer/electronic devices/machines. While not expressly described herein for purpose of brevity, it should be appreciated that the method and system of the present disclosure may be extended to and for use in other facilities associated with a user, such as residences, dormitories, gateways, lifts/elevators, secure locations or private locations that require security measures, travel-related facilities (e.g. airport boarding gates, coaches, trains, etc.), or electronic access gates or devices. Aspects of the present disclosure may be applied to physical access control and to virtual access control (e.g. for entry/access to a website or application).

While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

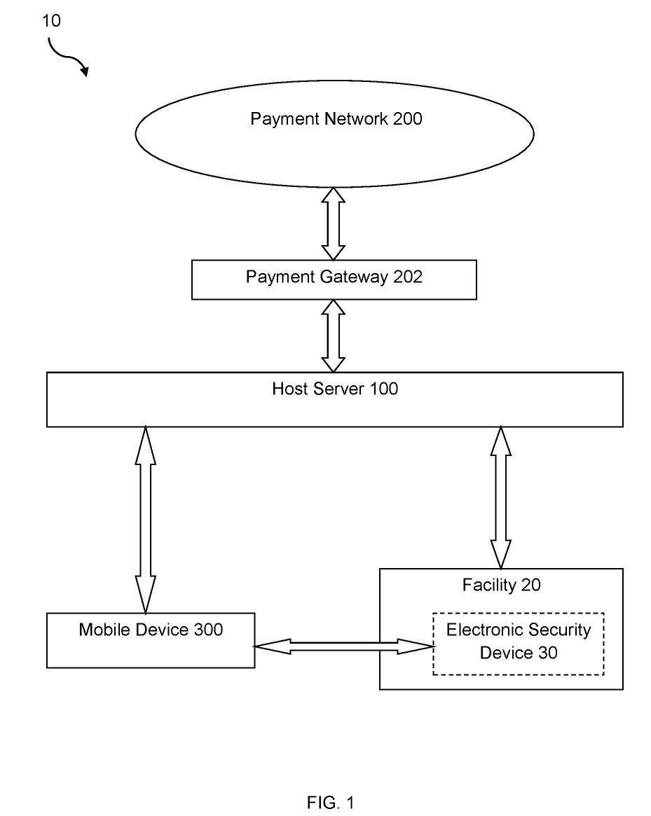

In representative or exemplary embodiments of the present disclosure, there is provided a system 10 as illustrated in FIG. 1. The system 10 comprises a host server 100 having a processor and a memory configured to store computer-readable instructions. The host server 100 is operative for performing a method of controlling access to a facility 20 associated with a user. More broadly, the system 10 is configured for controlling access to the facility 20, wherein the facility 20 is initially in a secured/locked/inaccessible state for preventing access thereto. It may be appreciated that the facility 20 is internet-enabled or has internet connectivity according to known internet/network infrastructure, such that the facility 20 is communicable to the host server 100. The internet-enabled facility 20, together with other internet-enabled facilities 20 associated with the user, may be part of an internetworking of facilities 20, such that each facility 20 has network connectivity that enables collection and exchange of data with one another. Accordingly, each facility 20, including electronic devices constituting the facility 20, may be part of the user's internet of things (IoT) and may be alternatively known as an IoT device. It may also be appreciated that each IoT device of the user is communicatively linked within the system 10, and that all data communication within the system 10 may be in secured form, e.g. by tokenization, encryption, and/or with use of digital security certificates.

The host server 100 is further communicatively linked to a payment network 200, such as via a payment gateway 202. The payment network 200 comprises an interlinked network of financial institutions (e.g. banks and credit card institutions) associated with payment cards (e.g. credit cards) or other payment vehicles of the user. The term “payment vehicle” may refer to any suitable cashless payment mechanism, such as a credit card, a debit card, a prepaid card, a charge card, a membership card, a promotional card, a frequent flyer card, an identification card, a gift card, and/or any other payment cards that may hold payment card information (e.g. details of user account or payment card) and which may be stored electronically on a mobile device.

The facility 20 may be secured or locked with an electronic security device 30. The electronic security device 30 may be an electronic or digital lock for maintaining the facility 20 in the secured/locked/inaccessible state. The electronic security device 30 thus prevents unauthorized people to deactivate the electronic security device 30 and gain access to the facility 20. The electronic security device 30 may be designed to read data from an external input in order to deactivate itself to unsecure/unlock/release the facility 20 so that the user may be able to access the facility 20 and use it. The data communicated with the electronic security device 30 may be in the form of Near-Field Communication (NFC) data (or other forms of wireless communication data, e.g. Bluetooth or Wi-Fi) and/or a matrix barcode such as a QR code. Accordingly, the electronic security device 30 is configured for performing communication for the facility 20. In embodiments of the present disclosure, data communication to/from the facility 20 may alternatively be interpreted as being performed by the electronic security device 30 of the facility 20.

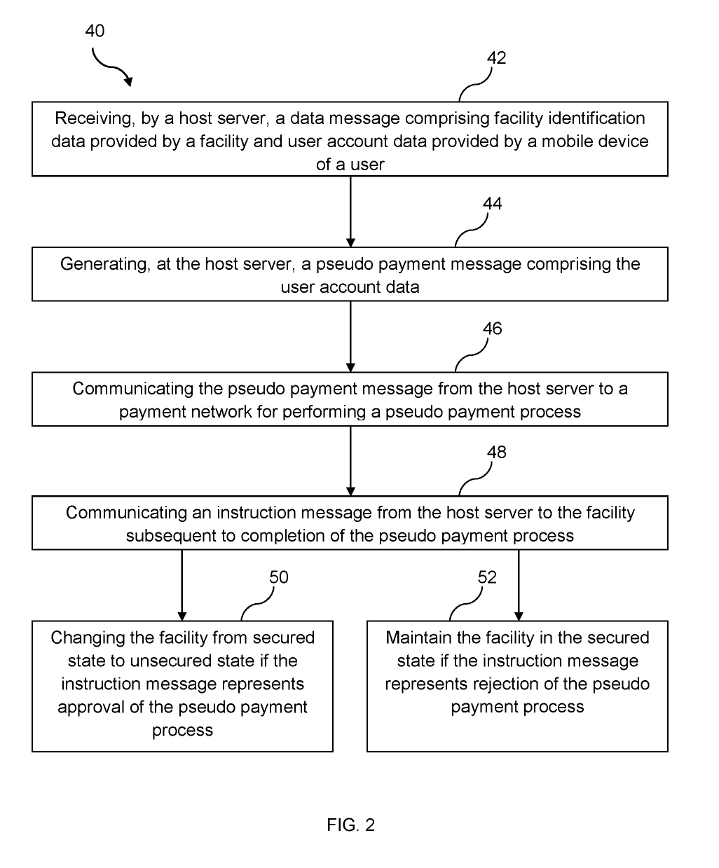

An electronic device of the user, e.g. a mobile device 300, is configured to be in communication within the system 10 for the user to gain access to the facility 20. The mobile device 300 may include mobile phones, smartphones, smart watches, wearable devices, personal digital assistants (PDAs), key fobs, transponder devices, NFC-enabled devices, tablets, portable display devices, and/or computers. Referring to FIG. 2, there is a method 40 for controlling access to the facility 20. Particularly, the method 40 is a computerized method 40 performed by a processor of the host server 100 for controlling access to the facility 20. The mobile device 300 is communicable with the internet-enabled facility 20 for the host server 100 to perform the method 40.

The method 40 comprises a step 42 of receiving, by the host server 100, a data message comprising facility identification data provided by the facility and user account data provided by a mobile device of the user. The data message may be communicated from the mobile device 300 to the host server 100 or from the facility 20 to the host server 100. Alternatively, the data message received by the host server 100 may be a combination of data messages communicated from the mobile device 200 and the facility 20. The facility identification data may comprise an identification number that uniquely identifies the facility 20. The user account data may comprise user identification data (e.g. user identification number) and details of a user payment vehicle (e.g. credit card). The user account data may further comprise user authentication data for authenticating transactions made with the user payment vehicle. The presence or extent of such authentication features for the user payment vehicle may be dependent on the type of user payment vehicle. The user authentication data may include an alphanumeric passcode or password (e.g. comprising of or using letters, numbers, punctuation marks, and/or symbols). Alternatively or additionally, the user authentication data may include biometric data of the user. The biometric data may include, but is not limited to, a photo of the face, fingerprint(s), and/or retinal information of the user.

The user may initiate the method 40 to unlock the facility 20 or electronic security device 30 with his/her mobile device 300. Specifically, the method 40 may be initiated when the mobile device 300 is located in the vicinity of the facility 20/electronic security device 30, e.g. directly in front thereof, such that mobile device 300 is within range for data communication with the facility 20/electronic security device 30. This also provides an initial confirmation that the user is holding the mobile device 300 at/near/outside the facility 20/electronic security device 30.

The method 40 further comprises a step 44 of generating, by the host server 100, a pseudo payment message comprising the user account data. The method 40 further comprises a step 46 of communicating the pseudo payment message from the host server 100 to the payment network 200 for performing a pseudo payment process. The pseudo payment message emulates an actual payment message that comprises the user payment vehicle details contained within the user account data. An actual payment message communicated to the payment network 200 would cause the payment network 200 to perform an actual payment process, i.e. a payment transaction with actual transfer of funds from the user payment vehicle. Although the pseudo payment message carries the user payment vehicle details, communication of the pseudo payment message to the payment network 200 would cause the payment network 200 to perform a pseudo payment process or an emulated payment process, i.e. imitate an actual payment process, such that there is no actual transfer of funds from the user payment vehicle.

The method 40 further comprises a step 48 of communicating an instruction message from the host server 100 to the facility 20 subsequent to completion of the pseudo payment process. In the step 48, the communication of the instruction message occurs directly between the host server 100 and the facility 20/electronic security device 30, without involvement of the mobile device 300. In a subsequent step 50, the facility 20 changes or transitions from the secured/locked/inaccessible state to the unsecured/unlocked/accessible state if the instruction message represents approval of the pseudo payment process, thereby providing, to the user, access to the facility 20. The electronic security device 30 may be deactivated to change the facility 20 from the secured state to the unsecured state, thereby releasing the facility 20 to the user for his/her usage. Conversely, in a step 52, if the instruction message represents rejection of the pseudo payment process, the electronic security device 30 remains activated and the facility 20 is maintained in the secured/locked/inaccessible state.

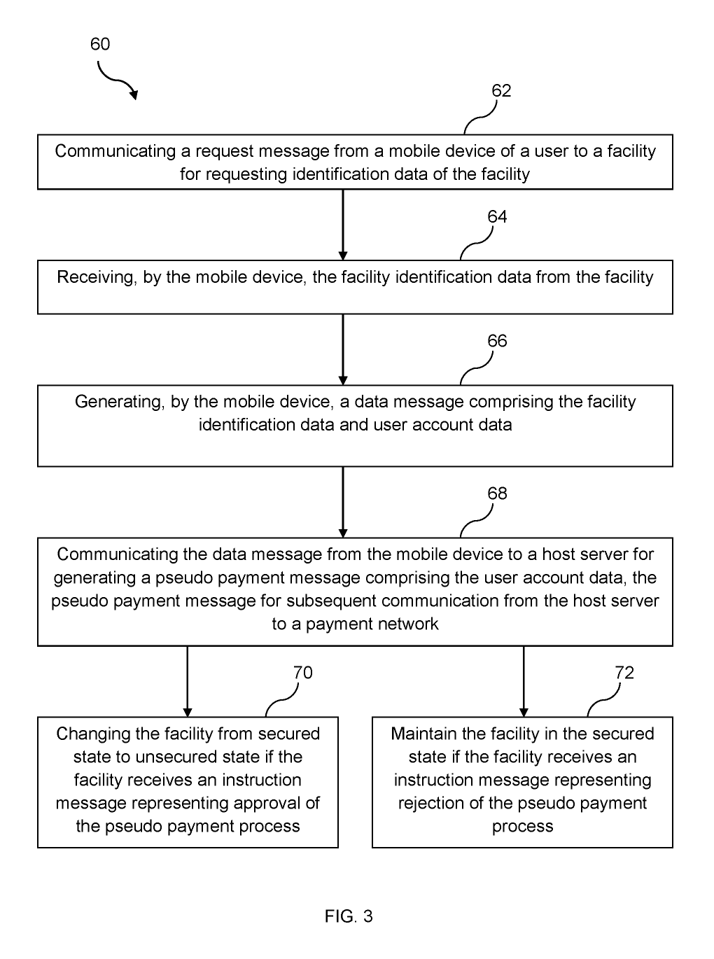

In some embodiments with reference to FIG. 3, there is a method 60 for controlling access to the facility 20 based on the perspective of the mobile device 300. Particularly, the method 60 is a computerized method 60 performed by a software application executable on the mobile device 300. The method 60 comprises a step 62 of communicating a request message from the mobile device 300 to the facility 20 for requesting identification data of the facility 20. The request message initiates the method 60 (and correspondingly the method 40) for controlling access to the facility 20. The request message is communicated from the mobile device 300 to the facility 20 when the mobile device 300 is located in the vicinity of the facility 20 (e.g. directly in front thereof). The method 60 further comprises a step 64 of receiving, by the mobile device 300, the facility identification data from the facility 20 in response to the request message being communicated from the mobile device 300 to the facility 20.

The method 60 further comprises a step 66 of generating, by the mobile device 300, a data message comprising the facility identification data and user account data; and a step 68 of communicating the data message from the mobile device 300 to the host server 100 for generating a pseudo payment message. The pseudo payment message comprises the user account data, e.g. the user payment vehicle details, and is generated by the host server 100 for subsequent communication from the host server 100 to the payment network 200.

In a subsequent step 70, the facility 20 changes from the secured state to the unsecured state if the facility 20 receives an instruction message representing approval of a pseudo payment process. The instruction message is communicated to the facility 20 subsequent to completion of the pseudo payment process by the payment network 200 based on the pseudo payment message. Specifically, communication of the instruction message occurs directly between the host server 100 and the facility 20, without involvement of the mobile device 300. Thus, in the step 70, if the facility 20 receives the instruction message representing approval of the pseudo payment process, the facility 20 would be released to the user for his/her usage. The electronic security device 30 may be deactivated to change the facility 20 from the secured state to the unsecured state, thereby providing, to the user, access to the facility 20. Conversely, in a step 72, if the instruction message represents rejection of the pseudo payment process, the electronic security device 30 remains activated and the facility 20 remains in the secured/locked/inaccessible state.

Thus, through the implementation of the method 40 on the host server 100, and correspondingly the method 60 on a software application executable on the mobile device 300, the user can make use of the mobile device 300 together with the host server 100, of the system 10 for access control to directly gain access to the facility 20, e.g. personal/private facilities 20 owned by the user or hospitality-related facilities 20 reserved by the user. For personal/private facilities 20 such as apartments and cars, the user can use the software application on his/her mobile device 300 to gain access to the facility 20. The same mobile device 300 can be used to gain access to multiple facilities 20 associated with or owned by the user, thereby providing a single sign-on (SSO) form of access control. The user thus does not need to carry and fumble through multiple sets of keys for different facilities 20, such as one set of key for his/her apartment and another set of keys for his/her car. For hospitality-related facilities 20 such as hotel rooms or rental vehicles, the user can bypass the conventional time-consuming check-in/accessing procedures at the reception area. Similarly, the user can use the mobile device 300 to gain access to the hotel room and rental vehicle, without having to carry multiple sets of keys. Between the mobile device 300 and a conventional physical key, it is less likely for the user to lose his/her mobile device 300. Thus, the risk of the user losing access to the facilities 20 is reduced, as compared to that being the case if the user is carrying conventional sets of physical keys.

Another advantage is that the authentication of the user to ensure that the user is the intended person to access a facility 20 is performed by the pseudo payment process at the payment network 200. The pseudo payment process authenticates the user payment vehicle details in the same manner when the user makes a purchase. The user may be able to quickly gain access to the facility 20 simply by making a pseudo payment via the electronic security device 30, such as by waving a credit card in front of the electronic security device 30 (relying on NFC data communication). If the user payment vehicle requires further authentication, e.g. with passcode, signature, or biometric data, the user can rely on preexisting payment vehicle details (and preexisting reference authentication data if applicable for the payment vehicle) stored on the payment network 200, such as with one or more financial institutions which the user is a customer of. It would not be necessary for the user to create another set of reference authentication data, such as for a database of the host server 100. The same preexisting payment vehicle details (and preexisting reference authentication data if applicable) on the payment network 200 can be extended for use with other or all facilities 20 associated with the user, such that the user can use the mobile device 300 as an SSO device and rely on the preexisting payment vehicle details to gain access to the facilities 20, without needing to create multiple authentication data for accessing each facility 20. Therefore, the system 10 and methods 40 and 60 provide improved access control and also a more convenient SSO advantage for the user to gain access to one or more facilities 20.

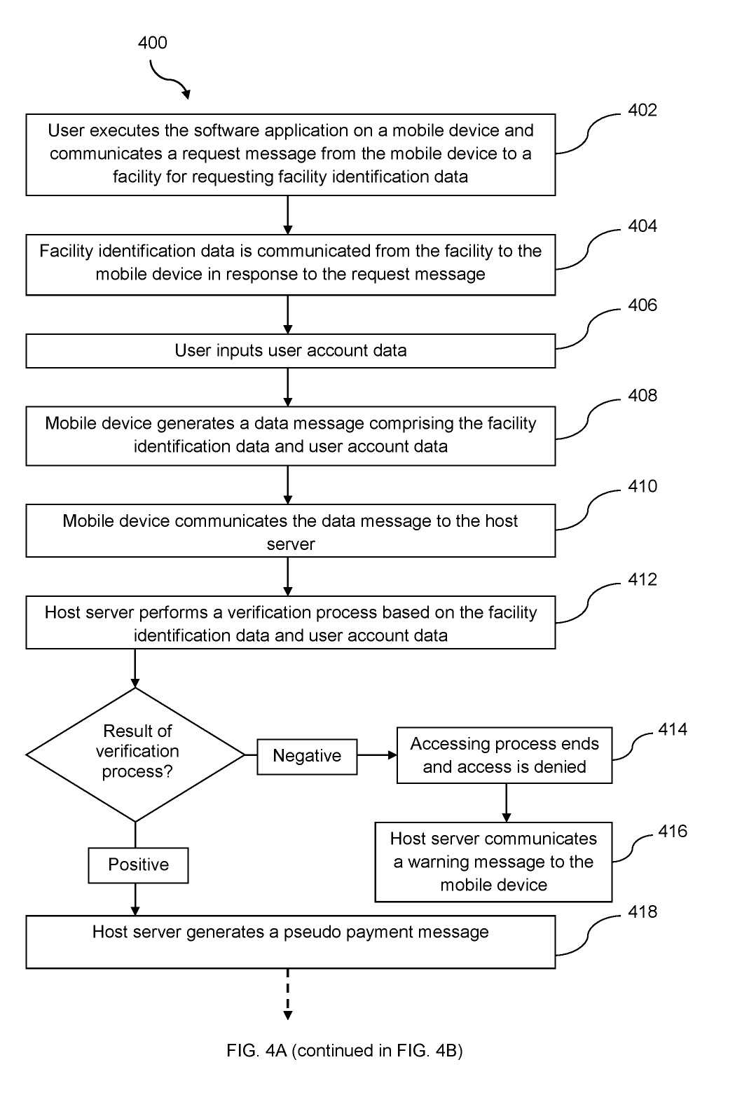

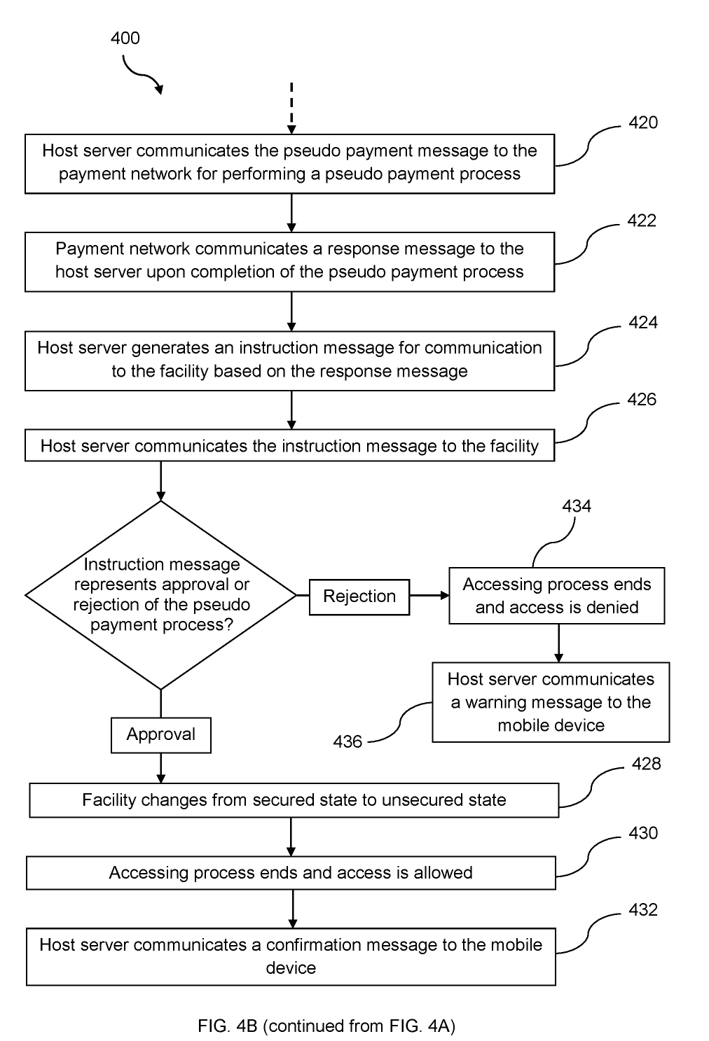

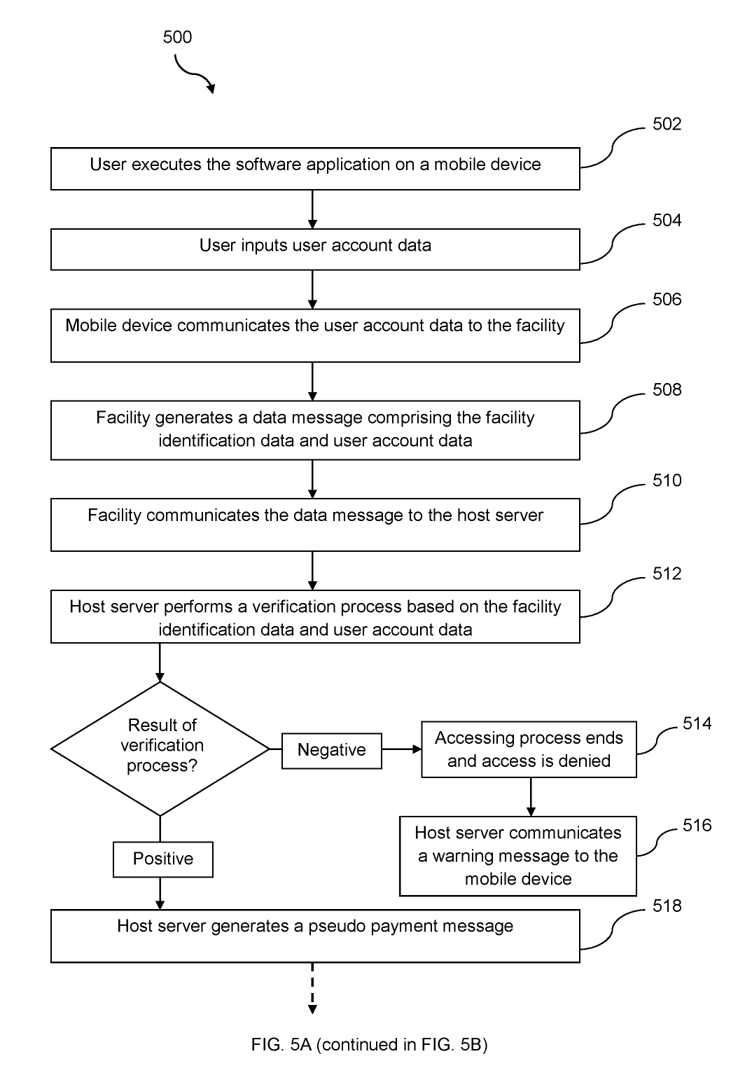

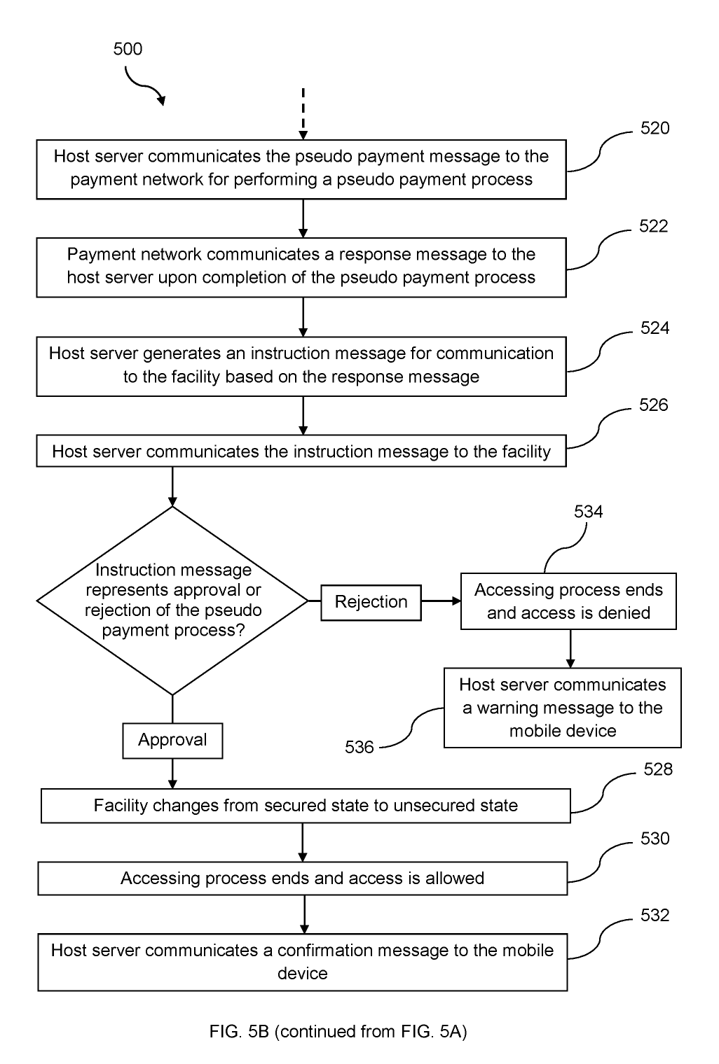

In various embodiments of the present disclosure, with reference to FIG. 4A to FIG. 5B, the software application for performing the method 40/60 to access a facility 20 is executable or executed by the user on the mobile device 300. The user may be required to perform a registration process on the mobile device 300 to associate a facility 20 with the user. During the registration process, the user may also associate other users to the facility 20, i.e. forming a group of users, such as if multiple users are authorized to access the facility 20 (e.g. members of a household). Groups of users may also be formed in situations such as if the user is reserving or booking the facility 20 as part of a group, e.g. tourist groups or teams of people for a hotel room, so that all members or participants of the same group as the user to gain access to the facility 20. The association of the facility 20 and the forming of groups of users may be performed, via a registration process, on the mobile device 300 or alternatively on a separate computing device. It would be readily apparent to the skilled person that the registration process is performed prior to the step 42 of the method 40.

If the user is a first-time user of the software application, the user may be required to download and install the software application on his/her mobile device 300. The user executes the software application and begins to create a user account. The creation of the user account may require the user to input and submit his/her user details. The user details may include, but not limited to, the user's full name, email address, phone number, address, nationality and identification number, such as national ID, driver's license ID, or passport number (to prevent duplicate accounts). The user details are communicated from the mobile device 300 to the host server 100 for further processing.

User identification data may then be generated by the host server 100. The user identification data may be a unique identifier generated by the host server 100, or generated based on the user details. The user identification data may be communicated to and made known to the user at the end of the registration process, so that the user may use the same user identification data to login to his/her user account. The newly-created user account is recorded on a user database of the host server 100. The user database may reside on the host server 100, or alternatively on a remote computer communicatively linked to the host server 100.

The user proceeds to add his/her payment vehicle details, e.g. of a credit card or digital wallet, to the user account. The payment vehicle details are required in order to rely on the payment network 200 for authenticating the user. The payment vehicle may be one that is associated with a financial institution of the payment network 200 and of which the user is a customer of. In some cases, the payment vehicle requires authentication by the user, such as in the form of a passcode, signature, and/or biometric data. The user authentication data (e.g. as part of the user account data carried by the data message during the step 42 or 66) would be authenticated against the preexisting reference authentication data stored on the payment network, such as with the financial institution. The reference authentication data may include reference passcode(s), signature(s), and/or reference biometric data.

Reference biometric data may comprise image data, such as a captured photo of the user's face and the mobile device 300 may comprise an image capture device or a camera for capturing the photo. The image data is thus a still image of the user's face. Alternatively, the image data may comprise a set of images, such as a series of images or a video sequence. Reference biometric data may alternatively or additionally comprise one or more fingerprints and the mobile device 300 may comprise a fingerprint reader for scanning and recording prints from at least one of the user's digits or fingers. Prints from multiple fingers may be scanned and recorded as reference biometric data so that the user may still rely on fingerprint recognition if one of his/her scanned fingers is injured such that a legible print or scan cannot be obtained. Reference biometric data may alternatively or additionally include retinal information of the user. The retinal information may be captured with an Intelligent Retinal Imaging System (IRIS) together with a high-definition camera of the mobile device 300 to scan or screen retinal information from the user's eye(s).

Upon successful registration of the user account, the user account would be identifiable by user account data. The user account data may comprise the user identification data and the user payment vehicle details. The user may subsequently associate facilities 20 with the user account, such that only facilities 20 associated with the user via the user account may be accessed using the methods 40 and 60 with the mobile device 300. A facility 20 may be locked or secured with an electronic security device 30. The electronic security device 30 may comprise an NFC component or other communications device for data communication with the mobile device 300. The electronic security device 30 of the facility 20 is associated with or identified by facility identification data. The facility identification data may be stored on the electronic security device 30 in a computer-readable format, e.g. in the form of Near-Field Communication (NFC) data (or other forms of wireless communication data, e.g. Bluetooth or Wi-Fi) and/or a matrix barcode such as a QR code.

The facility identification data may be registered on the user account with the mobile device 300 to associate the facility 20 with the user. This ensures only facilities 20 registered on the user account can be accessed by the user. For a private facility 20 owned by the user, the facility identification data may be communicated, e.g. via NFC, from the electronic security device 30 to the mobile device 300. If the private facility 20 does not have an electronic security device 30, i.e. is secured with a conventional lock, the user may install an electronic security device 30 to replace or augment the conventional lock. The facility identification data can then be communicated from the newly-installed electronic security device 30 to the mobile device 300. Alternatively, the facility identification data may be manually input by the user onto the user account, e.g. via the mobile device 300.

For a hospitality-related facility 20 such as a hotel room booked by the user, the facility identification data may be manually input by the user onto the user account, e.g. via the mobile device 300. The facility identification data for a hotel room may contain unique information that is specific to the hotel room and may be further specific to the reservation or booking of the hotel room. This information may include:
1. A unique identifier of the hotel room;
2. The dates and/or times/duration for using the hotel room;
3. User identification data when reserving the hotel room; and
4. Dynamic identifier based on the time stamp when reserving the hotel room.

The registration of the facility identification data may subsequently be communicated to the host server 100 for recording on the user database. Thus, by registering the facility identification data on the user account, the facility 20 becomes associated with the user, and the user would be able to use the mobile device 300 to gain access to the facility 20.

The user account created by the user may be associated with at least one other user account or with a group of user accounts. This allows multiple users to form a single group, i.e. the group of user accounts, each user account belonging to a user and created according to the above registration process. For clarity, the user initiating the creation of a group of user accounts will be referred to as the group leader. The grouping of users and user accounts facilitates multiple users to gain access to the same facility 20, such as if the users are a family staying together (for access to their home), or are part of a tourist group (for access to a hotel room or rental vehicle), or if the facility 20 is some equipment reserved for common usage by a group of people (e.g. a shared storage locker for a sports team).

Each user belonging to the group has their user payment vehicle details and reference authentication data stored on the payment network 200 and will be allowed to gain access to the facility 20, e.g. a hotel room reserved or booked by the group leader. Users of the group, who may be part of the same household, can also gain access to the facility 20, e.g. their house which may be owned by the group leader. Details of the user accounts in the group are recorded on the user database. Once a user has joined the group, he/she has the option to leave the group at any time. The group leader may also disband the group at any time. These may occur, for example, after a tour trip or team activity has ended. The software application may include a “Chat” function that allows users belonging to the same group to chat among themselves and stay updated about the activities associated with the facilities 20.

In one embodiment with reference to FIG. 4A and FIG. 4B, to access and use the facility 20, a user operates the software application on the mobile device 300 to perform an accessing process 400 based on the method 40 and method 60 to directly gain access to the facility 20.

The accessing process 400 comprises a step 402 wherein the user executes the software application on the mobile device 300 and communicates a request message from the mobile device 300 to the facility 20 for requesting the facility identification data. As mentioned above, communications for the facility 20 is performed by an electronic security device 30 thereof. Data communication between the facility 20 and the mobile device 300 may occur in the form of NFC data (or other forms of wireless communication data) or a matrix barcode, as desired by the user depending on the configuration of the mobile device 300 and/or the facility 20. For example, the communication between the mobile device 300 and the facility 20 may occur via a wireless communication protocol, e.g. NFC, Bluetooth low energy (BLE), or Wi-Fi. The mobile device 300 may be NFC-enabled and comprises an NFC component, and the facility 20 may likewise be NFC-enabled and comprise an NFC component, e.g. as part of the electronic security device 30. Alternatively, data may be embedded as a QR code displayed on the mobile device 300 or on the electronic security device 30. The mobile device 300 or electronic security device 30 may comprise an optical scanner to visually scan the QR code from a display screen of the electronic security device 30 or mobile device 300, respectively.

In the step 402, the request message is communicated from the mobile device 300 to the facility 20 when the mobile device 300 is located in the vicinity of the facility 20, e.g. directly in front thereof. In a step 404, the facility identification data is communicated from the facility 20 to the mobile device 300 in response to the request message. The facility identification data is thus shared between the facility 20 and the mobile device 300. After receiving the facility identification data, the user prepares to communicate a data message from the mobile device 300 to the host server 100.

In a step 406, the user inputs his/her user account data, e.g. the user payment vehicle details and user authentication data, on the mobile device 300. Alternatively, the user may login to his/her user account to retrieve the user account data, specifically the user payment vehicle details, from the user database before inputting the user authentication data on the mobile device 300. Notably, the user authentication data is not stored on the user database of the host server 100; manual input of the user authentication data is required to mitigate risk of fraudulent access to facilities 20. After retrieval and/or input of the user account data, the mobile device 300, in a step 408, generates a data message comprising the facility identification data and user account data. In a step 410, the mobile device 300 communicates the data message to the host server 100.

Upon receiving the data message from the mobile device 300, the host server 100, in a step 412, performs a verification process based on the facility identification data and user account data. A processor of the host server 100 verifies the facility identification data and user account data against the user database. Specifically, the verification process verifies whether the facility identification data is registered with the user account and whether the user has the authorization to access the facility 20. The verification process may additionally verify the user payment vehicle details in the user account data against the user database and determine whether they are valid. If the verification process yields a negative result, the accessing process 400 proceeds to a step 414 wherein the facility 20 remains in the secured state (the electronic security device 30 may correspondingly remain activated to maintain the facility 20 in the secured state) and the accessing process 400 ends and access is denied. There may be a step 416 wherein a warning message is communicated from the host server 100 to the mobile device 300 to inform the user that access to the facility 20 is denied.

If the verification process yields a positive result, the host server 100 proceeds to a step 418 to generate a pseudo payment message. The pseudo payment message comprises the user account data, specifically the user payment vehicle details and the user authentication data (if required for the user payment vehicle, e.g. digital wallet). Thus, the pseudo payment message is generated in response to positive verification from the verification process. In a step 420, the host server 100 communicates the pseudo payment message to the payment network 200 for performing a pseudo payment process.

As described above, the pseudo payment process is an emulated payment process without actual transfer of funds from the user payment vehicle. Thus, the pseudo payment process may comprise performing a zero value payment transaction with the user payment vehicle details. Alternatively, the pseudo payment process may comprise performing a pair of non-zero value transactions with the user payment vehicle details. Specifically, the pair of non-zero value transactions comprises a debit transaction and a credit transaction, wherein both credit and debit transactions have the same non-zero value. The credit transaction may be performed immediately after the debit transaction, such that the funds that are deducted from the user payment vehicle with the debit transaction are immediately refunded back with the credit transaction. The pseudo payment process performed by the payment network 200 thus performs an authentication of the user payment vehicle details, and consequently the user's identity, by emulating a payment transaction without actual transfer of funds; the user does not suffer any monetary loss as a result of the pseudo payment process.

It may be appreciated that the payment network 200, e.g. the financial institution of which the user is a customer of, may require additional verification of the user's identity, i.e. a second factor of authentication. For example, the payment network 200 may implement additional security measures such as an activation code or one-time password (OTP). The additional security measures may also include another form of biometric authentication which the user has to provide to the payment network 200. The use of two-factor authentication (2FA) to control access to the facility 20 may provide for stronger authentication and keep the facility 20 more secure.

In a step 422, the payment network 200 communicates a response message to the host server 100 upon completion of the pseudo payment process. The response message represents approval or rejection of the pseudo payment process, depending on whether the user payment vehicle details can be authenticated. In a step 424 after receiving the response message, the host server 100 generates an instruction message for communication to the facility 20 based on the response message. In a step 426, the host server 100 communicates the instruction message to the facility 20.

In a subsequent step 428, the facility 20 changes from the secured state to the unsecured state if the instruction message represents approval of the pseudo payment process, thereby providing, to the user, access to the facility 20. Accordingly, the accessing process 400 ends in a step 430 and the user is provided or allowed access to the facility 20. The host server 100 may additionally, in a step 432, communicate a confirmation message to the mobile device 300 in response to the facility 20 successfully changing from the secured state to the unsecured state. The user would thus be made known or informed of the successful release of the facility 20. This may be useful in the event that there is someone else or an impersonator who manages to successfully gain access to the facility 20 (e.g. by deactivating the electronic security device 30) owned or reserved by the user, the user would be quickly made aware of the situation.

Conversely, if the instruction message represents rejection of the pseudo payment process as indicated by the response message sent from the payment network 200 to the host server 100, the facility 20 would remain in the secured state. The accessing process 400 ends in a step 434 and the user is denied access to the facility 20. There may be a step 436 wherein a warning message is communicated from the host server 100 to the mobile device 300 to inform the user that access to the facility 20 is denied.

In another embodiment with reference to FIG. 5A and FIG. 5B, to access and use the facility 20, a user operates the software application on the mobile device 300 to perform an accessing process 500 based on the method 40 and method 60 to directly gain access to the facility 20. It would be appreciated that the various aspects/features/elements of the above-described embodiment of the accessing process 400 with reference to FIG. 4A and FIG. 4B may apply similarly or analogously to this embodiment of the accessing process 500 with reference to FIG. 5A and FIG. 5B. For purpose of brevity, such similar or analogous aspects/features/elements are not further elaborated upon.

The accessing process 500 comprises a step 502 wherein the user executes the software application on the mobile device 300. The user then proceeds to a step 504 to input his/her user account data, e.g. the user payment vehicle details and user authentication data, on the mobile device 300. Alternatively, the user may login to his/her user account to retrieve the user account data, specifically the user payment vehicle details, from the user database before inputting the user authentication data on the mobile device 300. Yet alternatively, the user account data, specifically the user payment vehicle details, may already be in a standby or communicative mode, e.g. embedded in an NFC component of the mobile device 300, such that the user is not required to manually input the user payment vehicle details or login to his/her user account, thereby expediting the step 504. The user would still be required to input the user authentication data on the mobile device 300 as the user authentication data is not stored on the user database or embedded in the NFC component of the mobile device 300.

After retrieval and/or input of the user account data, the mobile device 300, in a step 506, communicates the user account data to the facility 20. Specifically, the user account data is communicated, e.g. via NFC, from the mobile device 300 to the facility 20 when the mobile device 300 is located in the vicinity of the facility 20, e.g. directly in front thereof. The user account data is thus shared between the mobile device 300 and the facility 20. After receiving the user account data, the facility 20, in a step 508, generates a data message comprising the user account data together with facility identification data of the facility 20. In a step 510, the facility 20 communicates the data message to the host server 100.

Upon receiving the data message from the facility 20, the host server 100, in a step 512, performs a verification process based on the facility identification data and user account data. If the verification process yields a negative result, the accessing process 500 proceeds to a step 514 wherein the facility 20 remains in the secured state and the accessing process 500 ends and access is denied. There may be a step 516 wherein a warning message is communicated from the host server 100 to the mobile device 300 to inform the user that access to the facility 20 is denied.

If the verification process yields a positive result, the host server 100 proceeds a step 518 to generate a pseudo payment message. The pseudo payment message comprises the user account data and is generated in response to positive verification from the verification process. In a step 520, the host server 100 communicates the pseudo payment message to the payment network 200 for performing a pseudo payment process.

In a step 522, the payment network 200 communicates a response message to the host server 100 upon completion of the pseudo payment process. In a step 524 after receiving the response message, the host server 100 generates an instruction message for communication to the facility 20 based on the response message. In a step 526, the host server 100 communicates the instruction message to the facility 20.

In a subsequent step 528, the facility 20 changes from the secured state to the unsecured state if the instruction message represents approval of the pseudo payment process, thereby providing, to the user, access to the facility 20. Accordingly, the accessing process 500 ends in a step 530 and the user is provided or allowed access to the facility 20. The host server 100 may additionally, in a step 532, communicate a confirmation message to the mobile device 300 in response to the facility 20 successfully changing from the secured state to the unsecured state.

Conversely, if the instruction message represents rejection of the pseudo payment process, the facility 20 would remain in the secured state. The accessing process 500 ends in a step 534 and the user is denied access to the facility 20. There may be a step 536 wherein a warning message is communicated from the host server 100 to the mobile device 300 to inform the user that access to the facility 20 is denied.

Therefore, by using the accessing process 400/500 based on the method 40 and method 60 of the present disclosure, the user can directly gain access to the facility 20. The same mobile device 300 can be used to gain access to multiple facilities 20 associated with the user, thereby providing a single sign-on (SSO) form of access control. The pseudo payment process enables authentication of the user payment vehicle details, and consequently the user's identity, in the same manner as the user making a purchase. The user can thus rely on preexisting payment vehicle details (and preexisting reference authentication data if applicable for the payment vehicle) stored on the payment network 200. The same preexisting payment vehicle details (and preexisting reference authentication data if applicable) on the payment network 200 can be extended for use with other or all facilities 20 associated with the user, such that the user can use the mobile device 300 as an SSO device and rely on the preexisting payment vehicle details to gain access to the facilities 200. Therefore, the system 10 and methods 40 and 60 provide improved access control for the user to gain access to one or more facilities 20.

Moreover, as the host server 100 and the payment network 200 controls a significant portion of the operations of the methods 40 and 60, there is an advantage in that the facility 20 requires minimal software and/or hardware upgrading. The system 10 can be scaled upwards so that the host server 100 and the payment network 200 can operate with multiple facilities 20, such as multiple facility assets owned by a user, hotel chains, or a fleet of rental vehicles.

In some embodiments, the host server 100 may store historical records of the accessing process 400/500. The historical records include a history or log of data and metadata associated with the accessing process 400/500, such as the users, dates, and times of the accessing a facility 20. Information on the historical records may be availed and accessible by an operator or management of the facility 20 and/or the user. For example, the availing of the historical records may be on demand only, i.e. the operator or management of the facility 20 and/or the user may make a request to the host server 100 to release the information on the historical records. Information on the historical records could help track past usage of facilities 20. The information could be more relevant to the operator or management of the facilities 20 as data analytics may be applied on the information to derive useful data, such as knowing important user habit-related parameters, user interests in their services, food preferences, etc. The data obtained could assist in future marketing and branding strategies of the facilities 20. The information may be extended for use auditing purposes or for security reasons, such as analysis of human traffic at public places. The information may also be used to obtain data on who has entered (e.g. for employees) or visited (e.g. for customers) certain places, such as restaurants, amusement parks, cinemas, airports, etc.

Various embodiments of the present disclosure may be applied to scenarios wherein the user may use his/her mobile device 300 to gain access to a facility 20 via the accessing process 400/500, as described below. In some embodiments, the facility 20 may be owned by the user, i.e. permanently belonging to the user or at least for a significant period of time in the future. These “permanent” facilities 20 may include, but are not limited to, residences, mailboxes, and private vehicles. In some other embodiments, the facility 20 may be temporarily owned or belonging to the user, e.g. a temporary reservation or booking. These “temporary” facilities 20 may include, but are not limited to, hotel rooms and rental vehicles.

In some embodiments, the facility 20 may be a private residence or apartment of the user. The facility 20 may alternatively be a hotel room or a rental car booked by the user. The facility 20 may yet alternatively be some equipment for the user to use, e.g. mailboxes, storage lockers, and bank deposit boxes. The facility 20 is initially in the secured state for preventing access thereto, and is maintained as such with an electronic security device 30. The electronic security device 30 may be an electronic or digital lock which may be positioned on a door of the facility 20. In order to gain access to the facility 20, the user may use his/her mobile device 300 to perform the accessing process 400/500. Communication between the mobile device 300 and the facility 20 or electronic security device 30 may occur wirelessly, e.g. via NFC. Authentication of the user's identity is based on the user payment vehicle details and is performed by a pseudo payment process on the payment network 200.

Upon approval of the pseudo payment process and positive authentication of the user's identity, the electronic security device 30 deactivates to change the facility 20 from the secured state to the unsecured state, thereby releasing the facility 20 to the user for his/her usage. It should also be appreciated that the facility 20 would have network or internet connectivity in order to communicate with the host server 100 for performing the accessing process 400/500.

Further, the facility 20 may automatically return to or revert back to the secured state after a predetermined duration has lapsed since the change from the secured state to the unsecured state. For example, after the user has unlocked the facility 20, the electronic security device 30 may re-activate itself to re-lock the facility 20, i.e. change back to the secured state, after a predetermined duration of time has lapsed, e.g. after 30 seconds. This is to ensure that the facility 20 is almost always maintained in the secured state for preventing access by unauthorized or unauthenticated people.

In some other embodiments, the facility 20 may be a software application, website, or online portal with virtual security measures that requires the user to login. The conventional login process may be replaced with the accessing process 400/500. These virtual security measures may be interpreted as the electronic security device 30 of the facility 20. In order to gain access to the facility 20, the user may use his/her mobile device 300 to perform the accessing process 400/500. Communication between the mobile device 300 and the electronic security device 30 (i.e. virtual security measure) may be performed with matrix barcodes or QR codes. The QR code may be displayed on a computer which the user is using to access the software application/website/online portal.

As described above, authentication of the user's identity is based on the user payment vehicle details and is performed by a pseudo payment process on the payment network 200. Upon approval of the pseudo payment process and positive authentication of the user's identity, the electronic security device 30 or virtual security measure deactivates to change the software application/website/online portal from the secured state to the unsecured state, thereby releasing the software application/website/online portal to the user for his/her usage. Similarly, the software application/website/online portal may automatically return to or revert back to the secured state after a predetermined duration has lapsed since the change from the secured state to the unsecured state.

The following is a description of the technical architectures of the host server 100 and mobile device 300.

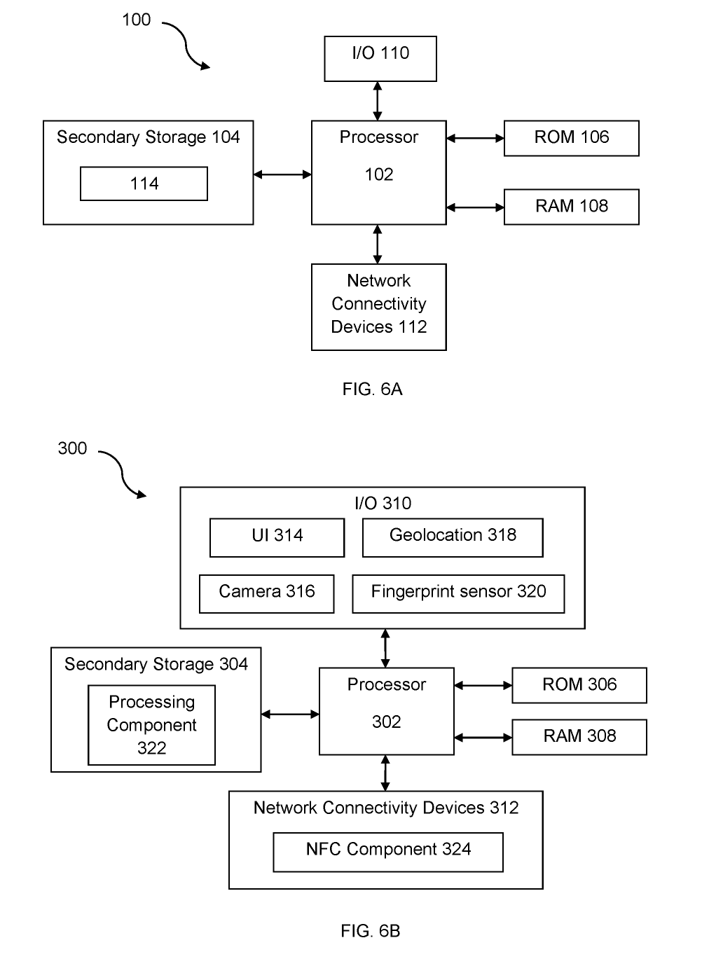

FIG. 6A illustrates a block diagram showing a technical architecture of the host server 100. The technical architecture includes a processor 102 (which may be referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. The technical architecture further comprises input/output (I/O) devices 110, and network connectivity devices 112.

The secondary storage 104 is typically comprised of a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, comprising non-transitory instructions operative by the processor 102 to perform various operations of the methods 40 and 60 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 60. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It should be appreciated that the technical architecture of the host server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

FIG. 6B illustrates a block diagram showing a technical architecture of the mobile device 300. The technical architecture includes a processor 302 (which may be referred to as a central processor unit or CPU) that is in communication with memory devices including secondary storage 304 (such as disk drives or memory cards), read only memory (ROM) 306, and random access memory (RAM) 308. The processor 302 may be implemented as one or more CPU chips. The technical architecture further comprises input/output (I/O) devices 310, and network connectivity devices 312.

The I/O devices 310 comprise a user interface (UI) 314 and an image capture device or camera 316. The mobile device 300 may further include a geolocation module 318. The UI 314 may comprise a touch screen, keyboard, keypad or other known input devices, e.g. fingerprint sensor 320. The camera 316 allows a user to capture image data and save the captured image data in electronic form on the mobile device 300, e.g. on the secondary storage 304. The fingerprint sensor 320 allows a user to read and capture his/her fingerprint for subsequent analysis. The geolocation module 318 is operable to determine the geolocation of the mobile device 300 using signals from, for example global positioning system (GPS) satellites.

The secondary storage 304 is typically comprised of a memory card or other storage device and is used for non-volatile storage of data and as an over-flow data storage device if RAM 308 is not large enough to hold all working data. Secondary storage 304 may be used to store programs which are loaded into RAM 308 when such programs are selected for execution.

The secondary storage 304 has a processing component 322, comprising non-transitory instructions operative by the processor 302 to perform various operations of the method 40 according to various embodiments of the present disclosure. The ROM 306 is used to store instructions and perhaps data which are read during program execution. The secondary storage 304, the ROM 306, and/or the RAM 308 may be referred to in some contexts as computer-readable storage media and/or non-transitory computer-readable media. Non-transitory computer-readable media include all computer-readable media, with the sole exception being a transitory propagating signal per se.

The network connectivity devices 312 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. For example, the network connectivity devices 312 include an NFC component 324 of the mobile device 300. These network connectivity devices 312 may enable the processor 302 to communicate with the Internet or one or more intranets. With such a network connection, it is contemplated that the processor 302 might receive information from the network, or might output information to the network in the course of performing the operations or steps of the method 40. Such information, which is often represented as a sequence of instructions to be executed using processor 302, may be received from and outputted to the network, for example, in the form of a computer data signal embodied in a carrier wave.

The processor 302 executes instructions, codes, computer programs, scripts which it accesses from hard disk, floppy disk, optical disk (these various disk based systems may all be considered secondary storage 304), flash drive, ROM 306, RAM 308, or the network connectivity devices 312. While only one processor 302 is shown, multiple processors may be present. Thus, while instructions may be discussed as executed by a processor 302, the instructions may be executed simultaneously, serially, or otherwise executed by one or multiple processors 302.

It is understood that by programming and/or loading executable instructions onto the technical architecture of the host server 100 and/or mobile device 300, at least one of the CPU 102/302, the ROM 106/306, and the RAM 108/308 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

In the foregoing detailed description, embodiments of the present disclosure in relation to a method and system for controlling access to a facility are described with reference to the provided figures. The description of the various embodiments herein is not intended to call out or be limited only to specific or particular representations of the present disclosure, but merely to illustrate non-limiting examples of the present disclosure. For example, the system 10, method 40, and method 60 may be extended to and for use in facilities 20 not mentioned herein, such as residences, dormitories, gateways, lifts/elevators, secure locations or private locations that require security measures, travel-related facilities (e.g. airport boarding gates, coaches, trains, etc.), or electronic access gates or devices. It should be appreciated that the system 10, method 40, and method 60 may be further extended to and for use in other different or distinct facilities 20 which may be physical or virtual, as would be readily apparent to and understood by the skilled person based on the present disclosure.

The present disclosure serves to address at least some of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computerized method implemented on a host server for controlling access to a facility associated with a user, the facility initially in a secured state for preventing access thereto, the method comprising:
receiving a data message comprising facility identification data provided by the facility and user account data provided by a mobile device of the user;
generating a pseudo payment message comprising the user account data;
communicating the pseudo payment message to a payment network for performing a pseudo payment process; and
communicating an instruction message to the facility subsequent to completion of the pseudo payment process,
wherein the facility is configured to change from the secured state to an unsecured state if the instruction message represents approval of the pseudo payment process, thereby providing, to the user, access to the facility.

2. The method according to claim 1, further comprising performing a verification process based on the facility identification data and user account data.

3. The method according to claim 2, wherein the verification process comprises verifying the facility identification data and user account data against a user database.

4. The method according to claim 2, wherein the pseudo payment message is generated in response to positive verification from the verification process.

5. The method according to claim 1, further comprising receiving a response message from the payment network upon completion of the pseudo payment process, the response message representing approval or rejection of the pseudo payment process.

6. The method according to claim 5, further comprising generating the instruction message for communication to the facility based on the response message.

7. The method according to claim 1, wherein the user account data comprises user identification data and details of a user payment vehicle.

8. The method according to claim 7, wherein the user account data further comprises user authentication data.

9. The method according to claim 8, wherein the user authentication data comprises a passcode and/or biometric data.

10. The method according to claim 7, wherein the pseudo payment process comprises performing a zero value payment transaction with the user payment vehicle details.

11. The method according to claim 7, wherein the pseudo payment process comprises performing, with the user payment vehicle details, a non-zero value debit transaction and a credit transaction of the same non-zero value immediately thereafter.

12. The method according to claim 1, wherein the data message is communicated from the facility to the host server.

13. The method according to claim 12, wherein the user account data is communicated from the mobile device to the facility prior to the facility communicating the data message to the host server.

14. The method according to claim 12, wherein the user account data is communicated from the mobile device to the facility when the mobile device is located in the vicinity of the facility.

15. The method according to claim 1, wherein the data message is communicated from the mobile device to the host server.

16. The method according to claim 15, wherein the facility identification data is communicated from the facility to the mobile device prior to the mobile device communicating the data message to the host server.

17. The method according to claim 15, wherein the facility identification data is communicated from the facility to the mobile device in response to a request message communicated from the mobile device to the facility.

18. The method according to claim 17, wherein the request message is communicated from the mobile device to the facility when the mobile device is located in the vicinity of the facility.

19. The method according to claim 15, wherein the facility identification data is communicated from the facility to the mobile device when the mobile device is located in the vicinity of the facility.

20. The method according to claim 1, wherein the facility comprises an electronic security device configured for maintaining the facility in the secured state.

21. The method according to claim 20, wherein the electronic security device is further configured for performing communication for the facility.

22. The method according to claim 20, further comprising deactivating the electronic security device to change the facility from the secured state to the unsecured state if the instruction message represents approval of the pseudo payment process.

23. The method according to claim 1, further comprising communicating a confirmation message to the mobile device in response to the facility successfully changing from the secured state to the unsecured state.

24. The method according to claim 1, further comprising performing a registration process prior to the host server receiving of the data message.

25. The method according to claim 24, wherein the registration process comprises creating an account of the user, the user account identifiable by the user account data.

26. The method according to claim 25, wherein the registration process further comprises associating the facility identification data with the user account.

27. A computerized method implemented on a mobile device of a user for controlling access to a facility associated with the user, the facility initially in a secured state for preventing access thereto, the method comprising:
communicating a request message from the mobile device to the facility for requesting identification data of the facility;
receiving, by the mobile device, the facility identification data from the facility;
generating, by the mobile device, a data message comprising the facility identification data and user account data; and
communicating the data message from the mobile device to a host server for generating a pseudo payment message comprising the user account data, the pseudo payment message for subsequent communication from the host server to a payment network,
wherein the facility is configured to change from the secured state to an unsecured state if the facility receives an instruction message representing approval of a pseudo payment process, thereby providing, to the user, access to the facility; and
wherein the instruction message is communicated from the host server to the facility subsequent to completion of the pseudo payment process by the payment network based on the pseudo payment message.
